(19) United States
(12) Patent Application Publication
(10) Pub. No.: US 2025/0060865 A1
(43) Pub. Date: Feb. 20, 2025

(54) SCREEN CAPTURE METHOD, ELECTRONIC DEVICE, MEDIUM, AND PROGRAM PRODUCT

(71) Applicant: Huawei Technologies Co., Ltd., Shenzhen (CN)

(72) Inventors: Yunjing Zhao, Shenzhen (CN); Chaoran Chen, Shenzhen (CN)

(21) Appl. No.: 18/936,087

(22) Filed: Nov. 4, 2024

Related U.S. Application Data
(63) Continuation of application No. PCT/CN2023/102110, filed on Jun. 25, 2023.

(30) Foreign Application Priority Data
Aug. 31, 2022 (CN) 202211062802.6

(51) Int. Cl. G06F 3/0484; G06F 3/0481

(52) U.S. Cl. CPC G06F 3/0484; G06F 3/0481

(57) ABSTRACT

According to a screen capture method described herein, when a first instruction (for example, a screen capture instruction) is received at a first device, a first user interface of the first device is captured as a first screenshot image, and a second instruction is sent to a second device associated with the first device, so as to trigger capturing of a second user interface of the second device. Then the first device receives a second screenshot image for the second user interface from the second device. The first screenshot image and the second screenshot image are displayed on the first user interface.

### CROSS-REFERENCE TO RELATED APPLICATIONS

This application is a continuation of International Application No. PCT/CN2023/102110, filed on Jun. 25, 2023, which claims priority to Chinese Patent Application No. 202211062802.6, filed on Aug. 31, 2022. The disclosures of the aforementioned applications are hereby incorporated by reference in their entireties.

### TECHNICAL FIELD

This disclosure generally relates to the field of information technologies, and more particularly, to a screen capture method, an electronic device, a computer-readable storage medium, and a computer program product.

### BACKGROUND

With development of electronic technologies and the mobile Internet, a user may have more terminals such as a mobile phone, a tablet computer, a personal computer, and a smart home device (for example, a smart screen). Generally, each terminal is used independently. In a scenario in which a plurality of terminals need to be cooperatively used, for example, collaborative office, the user connects the plurality of terminals for use.

In some scenarios, the user often watches a video or a conference by using a notebook computer, and takes notes by using a tablet computer and a stylus. In view of this, a convenient cross-device operation solution is required to improve user experience.

### SUMMARY

According to some embodiments of this disclosure, a screen capture method, an electronic device, a medium, and a program product are provided, to reduce complexity and operation difficulty of screen capturing and subsequent operations, so as to improve user experience.

According to a first aspect of this disclosure, a screen capture method is provided. When a first instruction is received at a first device, a first user interface of the first device is captured as a first screenshot image, and a second instruction is sent to a second device associated with the first device, so as to trigger capturing of a second user interface of the second device. Then the first device receives a second screenshot image for the second user interface from the second device. The first screenshot image and the second screenshot image are displayed on the first user interface.

In view of this, according to the screen capture method of the first aspect of this disclosure, screens of all devices associated with one device can be captured on the device, so that a user can efficiently complete a screen capture operation. Therefore, the screen capture method according to the first aspect of this disclosure can avoid user operations such as switching between different devices, sending a picture, and receiving the picture. This improves user experience.

In some implementations, a screenshot display window, a first switching identifier associated with the first screenshot image, and a second switching identifier associated with the second screenshot image may be displayed on the first user interface, to display the first screenshot image and the second screenshot image on the first user interface. When a tap operation for the first switching identifier is received, the first device displays the first screenshot image in the screenshot display window. When a tap operation for the second switching identifier is received, the second screenshot image is displayed in the screenshot display window. In this manner, when the user completes the screen capture operation and intends to perform a further operation on a screenshot, a screenshot of each device can be displayed in a timely manner. This improves efficiency of the screen capture operation.

In some implementations, the first screenshot image may be displayed on the first user interface at a first priority, and the second screenshot image may be displayed on the first user interface at a second priority, to display the first screenshot image and the second screenshot image on the first user interface, where the first priority is higher than the second priority (for example, the first screenshot image is first displayed, and an option of switching to the second screenshot image is displayed, so that the user can select the option to display the second screenshot image). In this manner, when the user captures a screen for the first time, a screenshot of a screen capture triggering device is first displayed by default, to provide same user experience as when the user captures a screen of a single device, so as not to confuse the user. This improves user experience.

In some implementations, the method further includes: when a target operation is received at the first device, performing the target operation on at least one of the first screenshot image and the second screenshot image. In this manner, after the screenshot is displayed to the user, the user can conveniently perform a timely operation on the screenshot. This improves efficiency of the screen capture operation.

In some implementations, when a previous screenshot image of the first device is not operated and a previous screenshot image of the second device is operated, the second screenshot image is displayed by default on the first user interface, to display the first screenshot image and the second screenshot image on the first user interface. In this manner, a priority of a currently displayed screenshot image is determined based on a previous screen capture operation selected by the user. This further reduces a switching operation required by the user and improves user experience.

In some implementations, the method further includes: When the first instruction is received, the first device sends a third instruction to a third device associated with the first device, where the third instruction is used to trigger capturing of a third user interface of the third device. Then the first device receives a third screenshot image for the third user interface of the third device from the third device. The first screenshot image, the second screenshot image, and the third screenshot image are displayed on the first user interface at a predetermined priority, and the predetermined priority is associated with time at which a previous screenshot image of the first device, a previous screenshot image of the second device, and a previous screenshot image of the third device are operated. In this manner, when the user performs operations on a plurality of images, a priority of a currently displayed screenshot image is determined based on time at which the user performs an operation on a different screenshot in a previous screen capture operation, so that a screenshot mostly needed by the user is preferentially displayed. The further reduces operation steps of the user and improves an interaction manner.

In some implementations, the first user interface is an application interface, and the target operation may include inserting the at least one screenshot image at a target location on the application interface. In this manner, the user can add, based on only one screen capture operation, a screenshot of another device to an application of a device operated by the user. This improves efficiency of the screen capture operation.

In some implementations, the inserting the at least one screenshot image may include: displaying, on the application interface when a drag operation for a screenshot is received, an animation of moving the screenshot with the drag operation, and inserting the screenshot at the target location on the application interface based on a drag release operation performed by the user on the target location. In this manner, the user can insert the screenshot based on a simple drag operation. This improves user experience.

In some implementations, the target operation may include storing the screenshot in the first device when a tap operation is received in an area of the first user interface other than an area in which the screenshot is displayed. In this manner, the user can store a screenshot of each device just by performing the tap operation after the screen capture operation. This improves user experience.

In some implementations, the target operation may include editing the screenshot when a tap operation is received in an area of the first user interface in which the screenshot is displayed. In this manner, the user can edit a screenshot of each device just by performing the tap operation after the screen capture operation. This improves user experience.

In some implementations, the first user interface is a home screen of the first device, and at least one application identifier is displayed on the home screen. The target operation may include: processing, when an operation of dragging the screenshot onto an application identifier in the at least one application identifier is received, the at least one screenshot image in an application associated with the application identifier. In this manner, the user can edit a screenshot of each device just by performing the tap operation after the screen capture operation. This improves user experience.

In some implementations, the first device being associated with the second device indicates at least one of the following: an account for logging in to the first device is associated with an account for logging in to the second device, a network in which the first device is located is associated with a network in which the second device is located, and a distance between the first device and the second device is less than a threshold distance. In this manner, the user can perform screen capture operations on devices connected in various manners. This expands an application scope of the screen capture operation, and makes an interaction manner more convenient.

In some implementations, the method further includes disabling a screen capture function of one or more of the first device and the second device based on a screen capture disabling setting. In this manner, before or during a screen capture operation, the user can disable screen capture functions of some devices that are not commonly used or do not expect to be displayed. This improves user experience.

In some implementations, the method further includes displaying, on the first user interface of the first device based on a screen capture selection setting, a screenshot of one or more devices selected from the first device and the second device. In this manner, the user can select, before or during a screen capture operation, a device whose screen expects to be captured, so that the screen capture operation is more targeted. This improves user experience.

In some implementations, the first instruction includes at least one of the following: an operation of simultaneously pressing a power button and a volume button of the first device, a three-finger swipe-down operation, an operation of capturing a screen by opening a control center, an operation of capturing a screen by using a voice assistant, an operation of knocking a screen with a knuckle, and an operation of capturing a screen with a stylus. In this manner, the user can capture screens at different devices based on a most convenient screen capture operation. This improves user experience.

According to a second aspect of this disclosure, a screen capture apparatus is provided. The apparatus includes an instruction receiving module, configured to receive a first instruction at a first device; a screen capture module, configured to capture a first user interface of the first device as a first screenshot image in response to the first instruction; an instruction sending module, configured to send, in response to the first instruction, a second instruction to a second device associated with the first device, where the second instruction is used to trigger capturing of a second user interface of the second device; a screenshot receiving module, configured to receive a second screenshot image for the second user interface from the second device; and a screenshot display module, configured to display the first screenshot image and the second screenshot image on the first user interface.

According to a third aspect of this disclosure, an electronic device is provided. The electronic device includes a processor and a memory that stores instructions. When the instructions are executed by the processor, the electronic device is enabled to perform any method according to the first aspect and the implementations of the first aspect.

According to a fourth aspect of this disclosure, a computer-readable storage medium is provided. The computer-readable storage medium stores instructions. When the instructions are executed by a processor, an electronic device is enabled to perform any method according to the first aspect and the implementations of the first aspect.

According to a fifth aspect of this disclosure, a computer program product is provided. The computer program product includes instructions. When the instructions are executed by a processor, an electronic device is enabled to perform any method according to the first aspect and the implementations of the first aspect.

### BRIEF DESCRIPTION OF THE DRAWINGS

Features, advantages, and other aspects of implementations of this disclosure will become more apparent with reference to the accompanying drawings and with reference to the following detailed descriptions. Several implementations of this disclosure are shown herein by way of example, and not limitation. In the accompanying drawings:

FIG. 1A and FIG. 1B are diagrams of a hardware structure and a software structure of an electronic device that can implement an embodiment of this disclosure;

FIG. 2 is a block diagram of another electronic device that can implement an embodiment of this disclosure;

FIG. 3 is a diagram of an environment in which an embodiment of this disclosure can be implemented;

FIG. 4 is a diagram of a scenario in which an embodiment of this disclosure can be implemented;

FIG. 5 is a flowchart of a screen capture method according to an embodiment of this disclosure;

FIG. 6A to FIG. 6D are diagrams of graphical user interfaces (GUIs) of screen capture switching according to an embodiment of this disclosure;

FIG. 7A to FIG. 7H are diagrams of GUIs of screenshot display priority determining according to an embodiment of this disclosure;

FIG. 8A and FIG. 8B are diagrams of GUIs of screenshot insertion according to an embodiment of this disclosure;

FIG. 9A and FIG. 9B are diagrams of GUIs of screenshot saving according to an embodiment of this disclosure;

FIG. 10A and FIG. 10B are diagrams of GUIs of screenshot editing according to an embodiment of this disclosure;

FIG. 11A to FIG. 11C are diagrams of GUIs of a further operation for a screenshot according to an embodiment of this disclosure;

FIG. 12 is a diagram of a GUI of screen capture settings according to an embodiment of this disclosure;

FIG. 13A and FIG. 13B are diagrams of an example screen capture device according to an embodiment of this disclosure; and

FIG. 14 is a diagram of an example screen capture device according to another embodiment of this disclosure.

### DETAILED DESCRIPTION OF ILLUSTRATIVE EMBODIMENTS

The following describes some example implementations of this disclosure in more detail with reference to the accompanying drawings. Although some example implementations of this disclosure are shown in the drawings, it should be understood that this disclosure may be implemented in various forms and should not be limited by the example implementations set forth herein. Rather, these implementations are provided to make this disclosure more thorough and complete and to fully convey the scope of this disclosure to a person skilled in the art.

A term “include” and variants thereof used in this specification indicate open inclusion, that is, “include but is not limited to”. Unless otherwise stated, a term “or” means “and/or”. A term “based on” means “at least partially based on”. The terms “embodiments” and “some embodiments” represent “at least some embodiments”. Descriptions such as terms “first”, “second”, and “third” are used to distinguish different objects, do not represent a sequence, and do not impose a limitation that “first”, “second”, and “third” are different types.

Some procedures described in embodiments of this disclosure include a plurality of operations or steps that appear in a specific order. However, it should be understood that these operations or steps may not be performed or executed in parallel according to the order in which the operations or steps appear in embodiments of this disclosure. Sequence numbers of the operations are merely used to distinguish between different operations, and the sequence numbers themselves do not represent any execution order. In addition, these procedures may include more or fewer operations, these operations or steps may be performed in sequence or performed in parallel, and these operations or steps may be combined.

Generally, when a user intends to edit a screenshot image of another device on a local device, the user needs to first capture a screen of the another device, send a screenshot to the local device, and then perform a subsequent operation on the local device. The user needs to perform switching between different devices to perform operations such as capturing a screen, sending a picture, and receiving the picture. This makes operation steps complex and affects user experience.

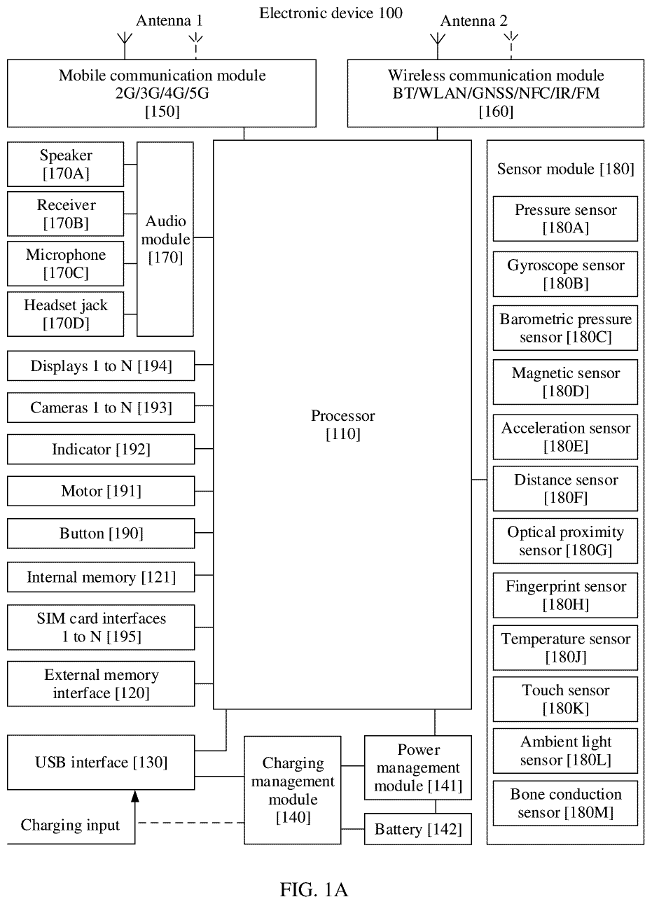

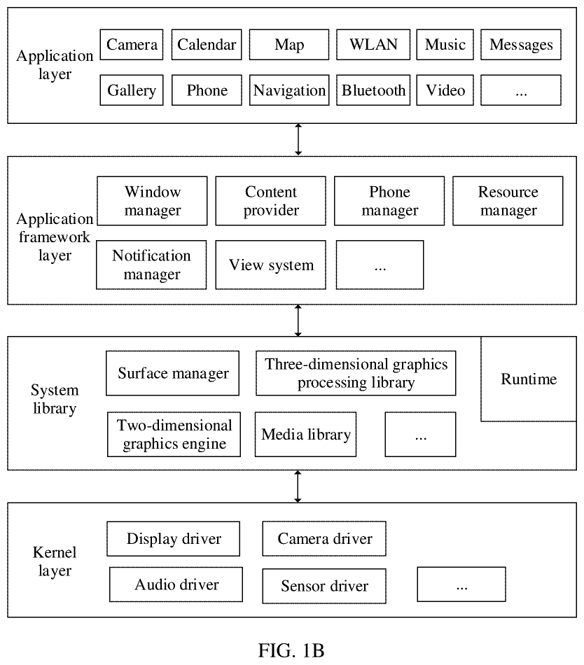

Therefore, an embodiment of this disclosure provides a new screen capture solution. In embodiments of this disclosure, screens of all devices associated with a device can be captured on only the device. This prevents the user from performing operations such as switching between different devices, sending a picture, and receiving the picture, reduces steps of completing cross-device screen capture, and reduces complexity and operation difficulty of a screen capture operation. After screen capture is completed, screenshots of the devices are displayed on a user interface of the device, so that the user can perform various subsequent operations on the screenshots. This improves user experience. The following describes some example embodiments of this disclosure with reference to FIG. 1 to FIG. 12.

FIG. 1A is a diagram of a hardware structure of an electronic device 100 that can implement an embodiment of this disclosure. As shown in FIG. 1, the electronic device 100 may include a processor 110, an external memory interface 120, an internal memory 121, a universal serial bus (USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identity module (SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It should be understood that the structure shown in this embodiment of this disclosure does not constitute a specific limitation on the electronic device 100. In some other embodiments of this disclosure, the electronic device 100 may include more or fewer components than those shown in the figure, or a combination of a part of the components, or splits from a part of the components, or an arrangement of different components. The components shown in the figure may be implemented by hardware, software, or a combination of software and hardware.

The processor 110 may include one or more processing units. For example, the processor 110 may include an application processor (AP), a modem processor, a graphics processing unit (GPU), an image signal processor (ISP), a controller, a video codec, a digital signal processor (DSP), a baseband processor, a neural-network processing unit (NPU), and/or the like. Different processing units may be independent components, or may be integrated into one or more processors. The controller may generate an operation control signal based on instruction operation code and a time sequence signal, to complete control of instruction reading and instruction execution.

A memory may be further disposed in the processor 110, and is configured to store instructions and data. In some embodiments, the memory in the processor 110 is a cache memory. The memory may store instructions or data just used or cyclically used by the processor 110. If the processor 110 needs to use the instructions or the data again, the processor 110 may directly invoke the instructions or the data from the memory. This avoids repeated access and reduces waiting time of the processor 110, so that system efficiency is improved.

In some embodiments, the processor 110 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a universal serial bus (USB) interface, and/or the like.

The I2C interface is a two-way synchronization serial bus, and includes one serial data line (SDA) and one serial clock line (SCL). In some embodiments, the processor 110 may include a plurality of groups of I2C buses. The processor 110 may be separately coupled to the touch sensor 180K, a charger, a flashlight, the camera 193, and the like through different I2C bus interfaces. For example, the processor 110 may be coupled to the touch sensor 180K through the I2C interface, so that the processor 110 communicates with the touch sensor 180K through the I2C bus interface, to implement a touch function of the electronic device 100.

The I2S interface may be configured to perform audio communication. In some embodiments, the processor 110 may include a plurality of groups of I2S buses. The processor 110 may be coupled to the audio module 170 through the I2S bus, to implement communication between the processor 110 and the audio module 170. In some embodiments, the audio module 170 may transmit an audio signal to the wireless communication module 160 through the I2S interface, to implement a function of answering a call through a Bluetooth headset.

The PCM interface may also be used for audio communication, and may perform sampling, quantizing, and encoding on an analog signal. In some embodiments, the audio module 170 may be coupled to the wireless communication module 160 through a PCM bus interface. In some embodiments, the audio module 170 may alternatively transmit an audio signal to the wireless communication module 160 through the PCM interface, to implement a function of answering a call through a Bluetooth headset. Both the I2S interface and the PCM interface may be configured to perform audio communication.

The UART interface is a universal serial data bus, and is configured to perform asynchronous communication. The bus may be a two-way communication bus. The bus converts to-be-transmitted data between serial communication and parallel communication. In some embodiments, the UART interface is usually configured to connect the processor 110 to the wireless communication module 160. For example, the processor 110 communicates with a Bluetooth module in the wireless communication module 160 through the UART interface, to implement a Bluetooth function. In some embodiments, the audio module 170 may transmit an audio signal to the wireless communication module 160 through the UART interface, to implement a function of playing music through a Bluetooth headset.

The MIPI interface may be configured to connect to the processor 110 and a peripheral component like the display 194 or the camera 193. The MIPI interface includes a camera serial interface (CSI), a display serial interface (DSI), and the like. In some embodiments, the processor 110 communicates with the camera 193 through the CSI interface, to implement a photographing function of the electronic device 100. The processor 110 communicates with the display 194 through the DSI, to implement a display function of the electronic device 100.

The GPIO interface may be configured by software. The GPIO interface may be configured for a control signal or a data signal. In some embodiments, the GPIO interface may be configured to connect the processor 110 to the camera 193, the display 194, the wireless communication module 160, the audio module 170, the sensor module 180, or the like. The GPIO interface may be further configured as the I2C interface, the I2S interface, the UART interface, the MIPI interface, or the like.

The USB interface 130 is an interface conforming to a USB standard specification, and may be specifically a mini USB interface, a micro USB interface, a USB Type-C interface, or the like. The USB interface 130 may be configured to connect to a charger to charge the electronic device 100, or may be configured to exchange data between the electronic device 100 and a peripheral device, or may be configured to connect to a headset for playing audio through the headset. The interface may be further configured to connect to another electronic device like an AR device.

It may be understood that an interface connection relationship between the modules illustrated in this embodiment of this disclosure is merely an example for description, and does not constitute a limitation on the structure of the electronic device 100. In some other embodiments of this disclosure, the electronic device 100 may alternatively use an interface connection different from that in the foregoing embodiment, or a combination of a plurality of interface connections.

The charging management module 140 is configured to receive a charging input from the charger. The charger may be a wireless charger or a wired charger. In some embodiments of wired charging, the charging management module 140 may receive a charging input from a wired charger through the USB interface 130. In some embodiments of wireless charging, the charging management module 140 may receive a wireless charging input through a wireless charging coil of the electronic device 100. When charging the battery 142, the charging management module 140 may further supply power to the electronic device 100 by using the power management module 141.

The power management module 141 is configured to connect to the battery 142, the charging management module 140, and the processor 110. The power management module 141 receives an input from the battery 142 and/or the charging management module 140, and supplies power to the processor 110, the internal memory 121, the display 194, the camera 193, the wireless communication module 160, and the like. The power management module 141 may further be configured to monitor parameters such as a battery capacity, a battery cycle count, and a battery state of health (electric leakage or impedance). In some other embodiments, the power management module 141 may alternatively be disposed in the processor 110. In some other embodiments, the power management module 141 and the charging management module 140 may alternatively be disposed in a same device.

A wireless communication function of the electronic device 100 may be implemented by using the antenna 1, the antenna 2, the mobile communication module 150, the wireless communication module 160, the modem processor, the baseband processor, and the like. The antenna 1 and the antenna 2 are configured to: transmit and receive electromagnetic wave signals. Each antenna in the electronic device 100 may be configured to cover one or more communication frequency bands. Different antennas may be further multiplexed, to improve antenna utilization. For example, the antenna 1 may be multiplexed as a diversity antenna of a wireless local area network. In some other embodiments, an antenna may be used in combination with a tuning switch.

The mobile communication module 150 may provide a wireless communication solution that is applied to the electronic device 100 and that includes a 2G/3G/4G/5G or the like. The mobile communication module 150 may include at least one filter, a switch, a power amplifier, a low noise amplifier (low noise amplifier, LNA), and the like. The mobile communication module 150 may receive an electromagnetic wave through the antenna 1, perform processing such as filtering or amplification on the received electromagnetic wave, and transmit a processed electromagnetic wave to the modem processor for demodulation. The mobile communication module 150 may further amplify a signal modulated by the modem processor, and convert the amplified signal into an electromagnetic wave for radiation through the antenna 1. In some embodiments, at least some functional modules in the mobile communication module 150 may be disposed in the processor 110. In some embodiments, at least some functional modules in the mobile communication module 150 may be disposed in a same component as at least some modules of the processor 110.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal through an audio device (which is not limited to the speaker 170A and the receiver 170B), or displays an image or a video through the display 194. In some embodiments, the modem processor may be an independent component. In some other embodiments, the modem processor may be independent of the processor 110, and is disposed in a same component as the mobile communication module 150 or another functional module.

The wireless communication module 160 may provide a wireless communication solution that is applied to the electronic device 100 and that includes a wireless local area network (WLAN) (for example, a wireless fidelity (Wi-Fi) network), Bluetooth (BT), a global navigation satellite system (GNSS), frequency modulation (FM), a near field communication (NFC) technology, an infrared (IR) technology, or the like. The wireless communication module 160 may be one or more components integrating at least one communication processor module. The wireless communication module 160 receives an electromagnetic wave through the antenna 2, performs frequency modulation and filtering processing on the electromagnetic wave signal, and sends a processed signal to the processor 110. The wireless communication module 160 may further receive a to-be-sent signal from the processor 110, perform frequency modulation and amplification on the signal, and convert a processed signal into an electromagnetic wave for radiation through the antenna 2.

In some embodiments, the antenna 1 of the electronic device 100 is coupled to the mobile communication module 150, and the antenna 2 is coupled to the wireless communication module 160, so that the electronic device 100 can communicate with a network and another device by using a wireless communication technology. The wireless communication technology may include a global system for mobile communications (GSM), a general packet radio service (GPRS), code division multiple access (CDMA), wideband code division multiple access (WCDMA), time-division code division multiple access (TD-CDMA), long term evolution (LTE), BT, a GNSS, a WLAN, NFC, FM, an IR technology, and/or the like. The GNSS may include a global positioning system (GPS), a global navigation satellite system (GLONASS), a BeiDou navigation satellite system (BDS), a quasi-zenith satellite system (QZSS), and/or a satellite based augmentation system (SBAS).

The electronic device 100 implements a display function by using the GPU, the display 194, the application processor, and the like. The GPU is a microprocessor for image processing, and connects the display 194 to the application processor. The GPU is configured to: perform mathematical and geometric calculation, and render an image. The processor 110 may include one or more GPUs that execute program instructions to generate or change display information.

The display 194 is configured to display an image, a video, and the like. The display 194 includes a display panel. The display panel may be a liquid crystal display (LCD), an organic light-emitting diode (OLED), an active-matrix organic light-emitting diode (AMOLED), a flexible light-emitting diode (FLED), a mini-LED, a micro-LED, a micro-OLED, a quantum dot light-emitting diode (QLED), or the like. In some embodiments, the electronic device 100 may include one or N displays 194, where N is a positive integer greater than 1.

The electronic device 100 may implement a photographing function through the ISP, the camera 193, the video codec, the GPU, the display 194, the application processor, and the like. The ISP is configured to process data fed back by the camera 193. For example, during photographing, a shutter is pressed, light is transferred to a camera photosensitive element through a lens, an optical signal is converted into an electrical signal, and the camera photosensitive element transmits the electrical signal to the ISP for processing, to convert the electrical signal into an image visible to a naked eye. The ISP may further perform algorithm optimization on noise, brightness, and complexion of an image. The ISP may further tune parameters such as exposure and a color temperature of a photographing scenario. In some embodiments, the ISP may be disposed in the camera 193.

The camera 193 is configured to capture a static image or a video. An optical image of an object is generated through the lens, and is projected onto the photosensitive element. The photosensitive element may be a charge-coupled device (CCD) or a complementary metal-oxide-semiconductor (CMOS) phototransistor. The light-sensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format like RGB or YUV. In some embodiments, the electronic device 100 may include one or N cameras 193, where N is a positive integer greater than 1.

The digital signal processor is configured to process a digital signal, and may process another digital signal in addition to the digital image signal. For example, when the electronic device 100 selects a frequency, the digital signal processor is configured to perform Fourier transformation and the like on frequency energy.

The video codec is configured to: compress or decompress a digital video. The electronic device 100 may support one or more video codecs. In this way, the electronic device 100 may play or record videos in a plurality of coding formats, for example, moving picture experts group (MPEG)-1, MPEG-2, MPEG-3, and MPEG-4.

The NPU is a neural-network (NN) processing unit. The NPU quickly processes input information with reference to a structure of a biological neural network, for example, a transfer mode between human brain neurons, and may further continuously perform self-learning. The NPU may implement applications such as intelligent cognition of the electronic device 100, for example, image recognition, facial recognition, voice recognition, and text understanding.

The external memory interface 120 may be configured to connect to an external storage card, for example, a micro-SD card, to extend a storage capability of the electronic device 100. The external memory card communicates with the processor 110 through the external memory interface 120, to implement a data storage function. For example, files such as music and a video are stored in the external storage card.

The internal memory 121 may be configured to store computer-executable program code. The executable program code includes instructions. The internal memory 121 may include a program storage area and a data storage area. The program storage area may store an operating system, an application required by at least one function (for example, a sound playing function or an image playing function), and the like. The data storage area may store data (for example, audio data or an address book) and the like created when the electronic device 100 is used. In addition, the internal memory 121 may include a high-speed random access memory, or may include a nonvolatile memory, for example, at least one magnetic disk storage device, a flash memory, or a universal flash storage (UFS). The processor 110 runs the instructions stored in the internal memory 121 and/or the instructions stored in the memory disposed in the processor, to perform various function applications and data processing of the electronic device 100.

The electronic device 100 may implement audio functions, for example, a music playing function and a recording function, by using the audio module 170, the speaker 170A, the receiver 170B, the microphone 170C, the headset jack 170D, the application processor, and the like.

The audio module 170 is configured to convert digital audio information into an analog audio signal for output, and is also configured to convert analog audio input into a digital audio signal. The audio module 170 may be further configured to: encode and decode an audio signal. In some embodiments, the audio module 170 may be disposed in the processor 110, or some functional modules in the audio module 170 are disposed in the processor 110.

The speaker 170A, also referred to as a “loudspeaker”, is configured to convert an audio electrical signal into a sound signal. The electronic device 100 may be configured to listen to music or answer a call in a hands-free mode by using the speaker 170A.

The receiver 170B, also referred to as an “earpiece”, is configured to convert an electrical audio signal into a sound signal. When a call is answered or voice information is received by using the electronic device 100, the receiver 170B may be put close to a human ear to receive a voice.

The microphone 170C, also referred to as a “mike” or a “mic”, is configured to convert a sound signal into an electrical signal. When making a call or sending a voice message, a user may make a sound near the microphone 170C through the mouth of the user, to input a sound signal to the microphone 170C. At least one microphone 170C may be disposed in the electronic device 100. In some other embodiments, two microphones 170C may be disposed in the electronic device 100, to collect a sound signal and implement a noise reduction function. In some other embodiments, three, four, or more microphones 170C may alternatively be disposed in the electronic device 100, to collect a sound signal, implement noise reduction, and identify a sound source, so as to implement a directional recording function and the like.

The headset jack 170D is configured to connect to a wired headset. The headset jack 170D may be the USB interface 130, or may be a 3.5 mm open mobile terminal platform (OMTP) standard interface, or a cellular telecommunications industry association of the USA (CTIA) standard interface.

The pressure sensor 180A is configured to sense a pressure signal, and can convert the pressure signal into an electrical signal. In some embodiments, the pressure sensor 180A may be disposed on the display 194. There are many types of pressure sensors 180A such as a resistive pressure sensor, an inductive pressure sensor, and a capacitive pressure sensor. The capacitive pressure sensor may include at least two parallel plates made of conductive materials. When force is applied to the pressure sensor 180A, capacitance between electrodes changes. The electronic device 100 determines pressure intensity based on a change in the capacitance. When a touch operation is performed on the display 194, the electronic device 100 detects intensity of the touch operation by using the pressure sensor 180A. The electronic device 100 may also calculate a touch location based on a detection signal of the pressure sensor 180A. In some embodiments, touch operations that are performed in a same touch location but have different touch operation intensity may correspond to different operation instructions. For example, when a touch operation whose touch operation intensity is less than a first pressure threshold is performed on a messages application icon, an instruction for viewing an SMS message is executed. When a touch operation whose touch operation intensity is greater than or equal to a first pressure threshold is performed on a messages application icon, an instruction for creating a new SMS message is executed.

The gyroscope sensor 180B may be configured to determine a moving posture of the electronic device 100. In some embodiments, angular velocities of the electronic device 100 around three axes (namely, axes x, y, and z) may be determined by using the gyroscope sensor 180B. The gyroscope sensor 180B may be configured to implement image stabilization during photographing. For example, when the shutter is pressed, the gyroscope sensor 180B detects an angle at which the electronic device 100 jitters, calculates, based on the angle, a distance for which a lens module needs to compensate, and allows the lens to cancel the jitter of the electronic device 100 through reverse motion, to implement image stabilization. The gyroscope sensor 180B may also be used in a navigation scenario and a somatic game scenario.

The barometric pressure sensor 180C is configured to measure barometric pressure. In some embodiments, the electronic device 100 calculates an altitude based on the barometric pressure measured by the barometric pressure sensor 180C, to assist in positioning and navigation.

The magnetic sensor 180D includes a Hall sensor. The electronic device 100 may detect opening and closing of a flip cover by using the magnetic sensor 180D. In some embodiments, when the electronic device 100 is a clamshell phone, the electronic device 100 may detect opening and closing of a flip cover based on the magnetic sensor 180D. Further, a feature, for example, automatic unlocking upon opening of the flip cover is set based on a detected opening or closing state of the flip cover.

The acceleration sensor 180E may detect accelerations of the electronic device 100 in various directions (usually on three axes). When the electronic device 100 is static, the acceleration sensor 180E may detect a magnitude and a direction of gravity. The acceleration sensor 180E may be further configured to identify a posture of the electronic device, and is used in screen switching between a landscape mode and a portrait mode, a pedometer, or another application.

The distance sensor 180F is configured to measure a distance. The electronic device 100 may measure the distance in an infrared manner or a laser manner. In some embodiments, in a photographing scenario, the electronic device 100 may measure a distance by using the distance sensor 180F to implement quick focusing.

The optical proximity sensor 180G may include, for example, a light-emitting diode (LED) and an optical detector, for example, a photodiode. The light-emitting diode may be an infrared light-emitting diode. The electronic device 100 emits infrared light by using the light-emitting diode. The electronic device 100 detects infrared reflected light from a nearby object through the photodiode. When plenty of reflected light is detected, the electronic device 100 may determine that there is an object near the electronic device 100. When insufficient reflected light is detected, the electronic device 100 may determine that there is no object near the electronic device 100. The electronic device 100 may detect, by using the optical proximity sensor 180G, that the user holds the electronic device 100 close to an ear for a call, to automatically turn off a screen for power saving. The optical proximity sensor 180G may also be used in a smart cover mode or a pocket mode to automatically perform screen unlocking or locking.

The ambient light sensor 180L is configured to sense ambient light brightness. The electronic device 100 may adaptively adjust brightness of the display 194 based on the perceived ambient light brightness. The ambient light sensor 180L may also be configured to automatically adjust white balance during photographing. The ambient light sensor 180L may also cooperate with the optical proximity sensor 180G to detect whether the electronic device 100 is in a pocket, to avoid an accidental touch.

The fingerprint sensor 180H is configured to collect a fingerprint. The electronic device 100 may use a feature of the collected fingerprint to implement fingerprint-based unlocking, application lock access, fingerprint-based photographing, fingerprint-based call answering, and the like.

The temperature sensor 180J is configured to detect a temperature. In some embodiments, the electronic device 100 executes a temperature processing strategy based on the temperature detected by the temperature sensor 180J. For example, when the temperature reported by the temperature sensor 180J exceeds a threshold, the electronic device 100 lowers performance of a processor nearby the temperature sensor 180J, to reduce power consumption for thermal protection. In some other embodiments, when the temperature is less than another threshold, the electronic device 100 heats the battery 142 to prevent the electronic device 100 from being shut down abnormally due to a low temperature. In some other embodiments, when the temperature is lower than still another threshold, the electronic device 100 boosts an output voltage of the battery 142 to avoid abnormal shutdown caused by a low temperature.

The touch sensor 180K is also referred to as a “touch component”. The touch sensor 180K may be disposed on the display 194, and the touch sensor 180K and the display 194 constitute a touchscreen, which is also referred to as a “touchscreen”. The touch sensor 180K is configured to detect a touch operation performed on or near the touch sensor. The touch sensor may transfer the detected touch operation to the application processor to determine a type of the touch event. A visual output related to the touch operation may be provided on the display 194. In some other embodiments, the touch sensor 180K may alternatively be disposed on a surface of the electronic device 100 at a location different from a location of the display 194.

The bone conduction sensor 180M may obtain a vibration signal. In some embodiments, the bone conduction sensor 180M may obtain a vibration signal of a vibration bone of a human vocal-cord part. The bone conduction sensor 180M may also be in contact with a body pulse to receive a blood pressure beating signal. In some embodiments, the bone conduction sensor 180M may also be disposed in the headset, to obtain a bone conduction headset. The audio module 170 may obtain a speech signal through parsing based on the vibration signal that is of the vibration bone of the vocal-cord part and that is obtained by the bone conduction sensor 180M, to implement a speech function. The application processor may parse heart rate information based on the blood pressure beating signal obtained by the bone conduction sensor 180M, to implement a heart rate detection function.

The button 190 includes a power button, a volume button, and the like. The button 190 may be a mechanical button or a touch button. The electronic device 100 may receive a button input, and generate a button signal input related to user settings and function control of the electronic device 100.

The motor 191 may generate a vibration prompt. The motor 191 may be configured to provide an incoming call vibration prompt and a touch vibration feedback. For example, touch operations performed on different applications (for example, a photographing application and an audio playing application) may correspond to different vibration feedback effects. The motor 191 may also correspond to different vibration feedback effect for touch operations performed on different areas of the display 194. Different application scenarios (for example, a time reminder, information receiving, an alarm clock, and a game) may alternatively correspond to different vibration feedback effects. A touch vibration feedback effect may be further customized.

The indicator 192 may be an indicator light, and may be used to indicate a charging status or a power change, or may be used to indicate a message, a missed call, a notification, or the like.

The SIM card interface 195 is configured to connect to a SIM card. The SIM card may be inserted into the SIM card interface 195 or removed from the SIM card interface 195, to implement contact with or separation from the electronic device 100. The electronic device 100 may support one or N SIM card interfaces, where N is a positive integer greater than 1. The SIM card interface 195 can support a nano-SIM card, a micro-SIM card, a SIM card, and the like. A plurality of cards may be simultaneously inserted into a same SIM card interface 195. The plurality of cards may be of a same type or different types. The SIM card interface 195 may be compatible with different types of SIM cards. The SIM card interface 195 may further be compatible with an external storage card. The electronic device 100 interacts with a network through the SIM card, to implement functions such as conversation and data communication. In some embodiments, the electronic device 100 uses an eSIM, namely, an embedded SIM card. The eSIM card may be embedded into the electronic device 100, and cannot be separated from the electronic device 100.

A software system of the electronic device 100 may use a layered architecture, an event-driven architecture, a microkernel architecture, a micro service architecture, or a cloud architecture. In embodiments of this disclosure, a mobile operating system of a layered architecture is used as an example to describe a software structure of the electronic device 100.

FIG. 1B is a diagram of a software structure of the electronic device 100 according to an embodiment of this disclosure. In a layered architecture, software is divided into several layers, and each layer has a clear role and task. The layers communicate with each other through a software interface. In some embodiments, the operating system may be divided into four layers: an application layer, an application framework layer, an operating system runtime (runtime) and system library, and a kernel layer from top to bottom.

The application layer may include a series of application packages. As shown in FIG. 1B, the application packages may include applications such as Camera, Gallery, Calendar, Phone, Map, Navigation, WLAN, Bluetooth, Music, Video, and Messages.

The application framework layer provides an application programming interface (API) and a programming framework for an application at the application layer. The application framework layer includes some predefined functions.

As shown in FIG. 1B, the application framework layer may include a window manager, a content provider, a view system, a phone manager, a resource manager, a notification manager, and the like. The window manager is configured to manage a window program. The window manager may obtain a size of the display, determine whether there is a status bar, perform screen locking, take a screenshot, and the like. The content provider is configured to: store and obtain data, and enable the data to be accessed by an application. The data may include a video, an image, an audio, calls that are made and received, a browsing history, a bookmark, an address book, and the like. The view system includes a visual control, for example, a control for displaying a text or a control for displaying a picture. The view system may be used to construct an application. A display interface may include one or more views. For example, a display interface including a messages notification icon may include a text display view and a picture display view. The phone manager is configured to provide a communication function for the electronic device 100, for example, management of a call status (including answering, declining, or the like). The resource manager provides various resources such as a localized character string, an icon, an image, a layout file, and a video file for an application. The notification manager enables an application to display notification information in a status bar, and may be configured to convey a notification message. The notification manager may automatically disappear after a short pause without requiring a user interaction. For example, the notification manager is configured to notify download completion, give a message notification, and the like. The notification manager may alternatively be a notification that appears in a top status bar of the system in a form of a graph or a scroll bar text, for example, a notification of an application that is run in the background, or a notification that appears on a screen in a form of a dialog window. For example, text information is displayed in the status bar, an alert tone is played, the electronic device vibrates, or the indicator light blinks.

Continue to refer to FIG. 1B. The operating system runtime includes a kernel library and a virtual machine. The operating system runtime is responsible for scheduling and management of the operating system. The kernel library includes two parts: a function that needs to be called in Java language and a kernel library of the operating system. The application layer and the application framework layer are run on the virtual machine. The virtual machine executes Java files of the application layer and the application framework layer as binary files. The virtual machine is configured to implement functions such as object lifecycle management, stack management, thread management, security and exception management, and garbage collection. The system library may include a plurality of functional modules, for example, a surface manager, a media library, a three-dimensional graphics processing library (for example, OpenGL ES), and a two-dimensional graphics engine (for example, SGL).

The surface manager is configured to: manage a display subsystem and provide fusion of 2D and 3D layers for a plurality of applications. The media library supports playing and recording of a plurality of common audio and video formats, static image files, and the like. The media library may support a plurality of audio and video coding formats, such as MPEG-4, H.264, MP3, AAC, AMR, JPG, and PNG. The three-dimensional graphics processing library is configured to implement three-dimensional graphics drawing, image rendering, composition, layer processing, and the like. The two-dimensional graphics engine is a drawing engine for 2D drawing.

The kernel layer is a layer between hardware and software. The kernel layer includes at least a display driver, a camera driver, an audio driver, and a sensor driver.

The following describes an example of a working process of software and hardware of the electronic device 100 with reference to a photographing scenario. When the touch sensor 180K receives a touch operation, a corresponding hardware interruption is sent to the kernel layer. The kernel layer processes the touch operation into an original input event (including information such as touch coordinates and a time stamp of the touch operation). The original input event is stored at the kernel layer. The application framework layer obtains the original input event from the kernel layer, and identifies a control corresponding to the input event. For example, the touch operation is a touch tap operation and a control corresponding to the touch tap operation is a control of a camera application icon. A camera application invokes an interface at the application framework layer, to start the camera application. Then, the camera driver is started by invoking the kernel layer, and a static image or a video is captured by using the camera 193.

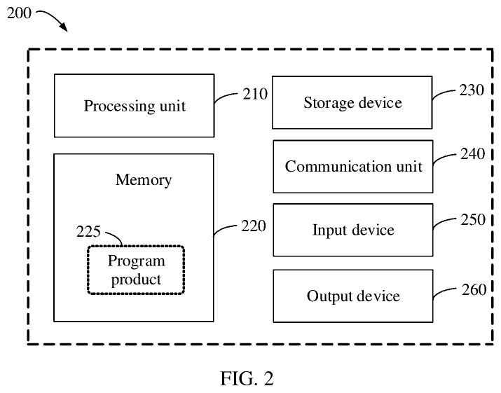

FIG. 2 is a block diagram of another electronic device 200 that can implement an embodiment of this disclosure. As shown in FIG. 2, the electronic device 200 may be in a form of a general-purpose computing device. Components of the electronic device 200 may include but are not limited to one or more processors or processing units 210, a memory 220, a storage device 230, one or more communication units 240, one or more input devices 250, and one or more output devices 260. The processing unit 210 may be a real or virtual processor and can perform various processing according to a program stored in the memory 220. In a multi-processor system, a plurality of processing units execute computer-executable instructions in parallel, to improve a parallel processing capability of the electronic device 200.

The electronic device 200 generally includes a plurality of computer storage media. The media may be any available media accessible to the electronic device 200, including but not limited to volatile and non-volatile media, and removable and non-removable media. The memory 220 may be a volatile memory (for example, a register, a cache, a random access memory (RAM)), a non-volatile memory (for example, a read-only memory (ROM), an electrically erasable programmable read-only memory (EEPROM), or a flash memory), or some combination thereof. The storage device 230 may be a removable or non-removable medium, and may include a machine-readable medium like a flash drive, a magnetic disk, or any other medium, which can store information and/or data (for example, training data for training) and can be accessed within the electronic device 200.

The electronic device 200 may further include additional removable/non-removable and volatile/non-volatile storage media. Although not shown in FIG. 2, a disk drive for reading or writing from a removable and non-volatile magnetic disk (for example, a “floppy disk”) and an optical disk drive for reading or writing from a removable and non-volatile optical disk may be provided. In these cases, each drive may be connected to a bus (not shown) through one or more data medium interfaces. The memory 220 may include a computer program product 225. The computer program product 225 has one or more program modules. The program modules are configured to perform a screen capture method or process in embodiments of this disclosure.

The communication unit 240 implements communication with another computing device by using a communication medium. Additionally, functions of the components of the electronic device 200 may be implemented as a single computing cluster or a plurality of computers capable of communicating through a communication connection. Therefore, the electronic device 200 can operate in a networked environment through a logical connection to one or more other servers, a networked personal computer (PC), or another network node.

The input device 250 may be one or more input devices such as a mouse, a keyboard, or a trackball. The output device 260 may be one or more output devices such as a display, a speaker, or a printer. In an embodiment of this disclosure, the output device 260 may include a touchscreen having a touch sensor that can receive a touch input from a user. The electronic device 200 may further communicate with one or more external devices (not shown) as required through the communication unit 240. The external device, for example, a storage device or a display device, communicates with one or more devices that enable the user to interact with the electronic device 200, or communicates with any device (for example, a network card or a modem) that enables the electronic device 200 to communicate with one or more other computing devices. Such communication may be performed through an input/output (I/O) interface (not shown).

It should be understood that the electronic device 100 shown in FIG. 1 and the electronic device 200 shown in FIG. 2 are merely two example electronic devices that can implement one or more embodiments of this disclosure, and should not constitute any limitation on functions and scopes of embodiments described in this specification.

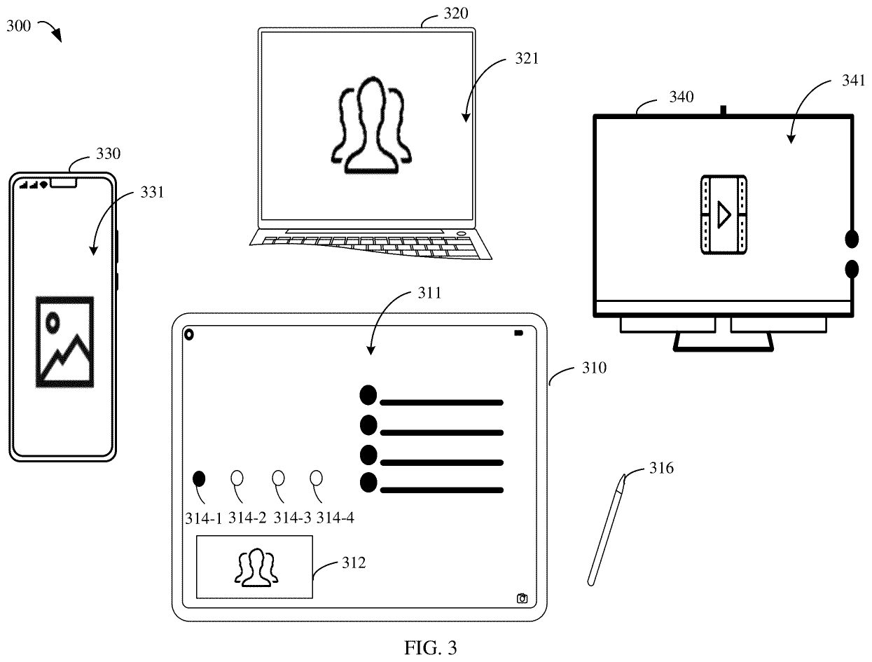

FIG. 3 is a diagram of an environment 300 in which an embodiment of this disclosure can be implemented. As shown in FIG. 3, the example environment 300 includes a plurality of devices such as a tablet computer 310 (and a stylus 316 of the tablet computer), a personal computer (PC) 320, a mobile phone 330, and a smart screen 340. Each device includes a user interface displayed to a user, for example, a user interface 311 of the tablet computer 310, a user interface 321 of the personal computer 320, a user interface 331 of the mobile phone 330, and a user interface 341 of the smart screen 340. An image or an image frame of a played video may be displayed on each user interface, and the image or the image frame is shown with a different icon. It should be understood that the devices, the user interfaces, and images displayed on the devices in the environment 300 are merely examples. There may be more types of devices in the environment 300. This is not limited in this disclosure.

As shown in the environment 300, after one of the plurality of devices receives a screen capture operation, a screenshot display window 312 and a plurality of switching identifiers 314-1, 314-2, 314-3, and 314-4 (hereinafter or collectively referred to as a switching identifier 314) may be displayed on the user interface of the device (the tablet computer 310 in FIG. 3), and each switching identifier is associated with a screenshot for the user interface of each device. This will be explained below.

It may be understood that, during cross-device screen capture, a first device and a second device may be respectively referred to as a screen capture triggering device and a screen-captured device based on different implementation functions of the first device and the second device. Specifically, the screen capture triggering device (or the first device) may be a device that receives a screen capture operation and sends a second instruction (for example, a screen capture instruction). The screen-captured device (or the second device) may be a device that receives the second instruction from the screen capture triggering device (or the first device).

It should be noted that devices in embodiments of this disclosure, such as the first device, the second device, and a third device described below, may be a mobile phone, a tablet computer, a handheld computer, a personal computer, a cellular phone, a personal digital assistant (PDA), a wearable device (for example, a smartwatch), a vehicle-mounted computer, a game console, or an augmented reality (AR) device/a virtual reality (VR) device. No special limitation is imposed on a specific form of the device in embodiments. In addition, the technical solutions provided in embodiments may be applied to another electronic device, for example, a smart home device (for example, a television), in addition to the device (or a mobile device). Device forms of the first device, the second device, and the third device may be the same or may be different. In the following descriptions, same reference numerals are used for same devices and user interfaces in different drawings. This is not limited in this disclosure.

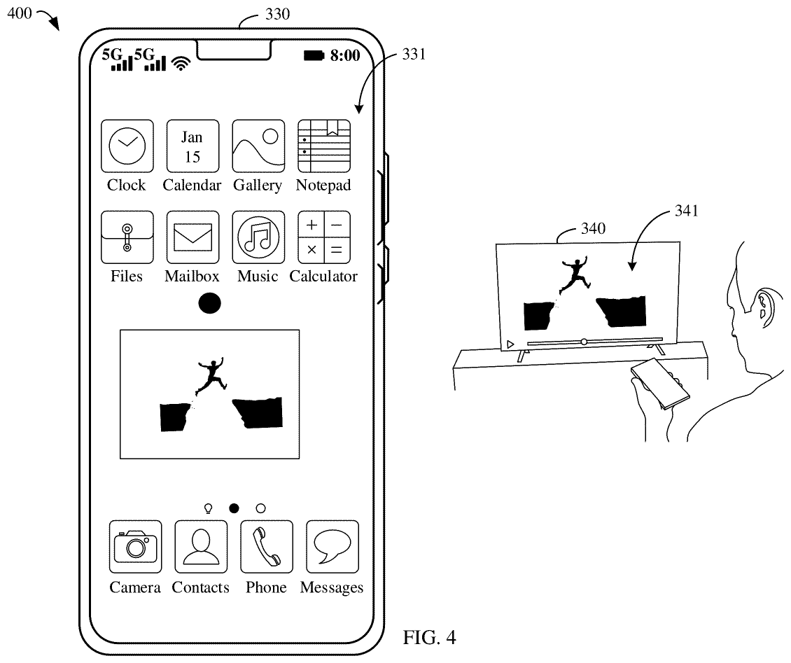

FIG. 4 is a diagram of a scenario 400 in which an embodiment of this disclosure can be implemented. In some embodiments, as shown in FIG. 4, the user is watching a movie on the smart screen 340. In a process of watching the movie, the user intends to capture a screen of the movie displayed on the user interface 341 of the smart screen 340, and send the screenshot by using the mobile phone 330 to a friend. In some other embodiments (not shown), the user simultaneously takes notes on the tablet computer 310, plays a video on the personal computer 320, performs a video call with a friend on the mobile phone 330, and performs a video conference on the smart screen 340. According to the method of embodiments of this disclosure, the user can perform a screen capture operation on only the tablet computer, and then send a screenshot of the video to a friend who is involved in the video call, and may further share a screenshot of a note that is being taken with another participant of the video conference. The following describes implementation of the screen capture operation and a subsequent operation in detail. It may be understood that the screen capture method in embodiments of this disclosure may be applied to various devices and scenarios. This is not limited in this disclosure.

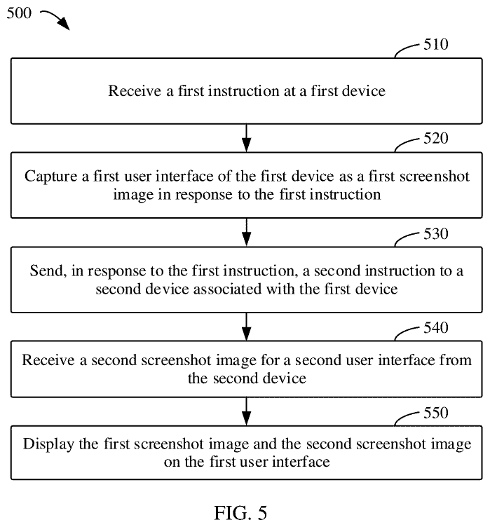

FIG. 5 is a flowchart of a screen capture method 500 according to an embodiment of this disclosure. For example, the method 500 may be performed by the tablet computer 310 described with reference to FIG. 3. Alternatively, the method 500 may be performed by another electronic device having a display. In a block 510, a first device detects that a first instruction is received. For example, the tablet computer 310 detects a touch operation on a display or an operation on a button by using a touch sensor of the tablet computer 310, to determine that the first instruction is received. The first instruction is, for example, a screen capture operation from a user. In some embodiments, for a different first device, there may be a different first instruction, for example, an operation of simultaneously pressing a power button and a volume button of the device, a three-finger swipe-down operation, an operation of capturing a screen by opening a control center, an operation of capturing a screen by using a voice assistant, an operation of knocking a screen with a knuckle, and an operation of capturing a screen with a stylus. In this manner, the user can capture screens at different devices based on a most convenient screen capture operation. This improves user experience. It should be understood that the screen capture operation is merely an example, and different screen capture operations may further exist based on different device forms and with technical development.

In a block 520, the first device captures a first user interface of the first device as a first screenshot image in response to the first instruction. For example, after detecting the screen capture operation from the user, the tablet computer 310 may capture an image of the user interface 311 and use the image as the first screenshot image. The first instruction may be the screen capture operation from the user or an instruction of the first device. The response means that an action of capturing the first screenshot image may be directly triggered by the first instruction or indirectly triggered by the first instruction.

In a block 530, the first device sends, in response to the first instruction, a second instruction to a second device associated with the first device, where the second instruction is used to trigger capturing of a second user interface of the second device. For example, after detecting the screen capture operation from the user, the tablet computer 310 sends the second instruction, for example, a screen capture instruction, to the mobile phone 330 associated with the tablet computer 310. It should be noted that an order of describing the block 520 and the block 530 is not intended to limit an order of capturing the first screenshot image and sending the second instruction. In addition, capturing of the first screenshot image and sending of the second instruction are not necessarily associated, that is, the action of capturing the first screenshot image is not necessarily accompanied by an action of sending the second instruction.

In some embodiments, based on screen capture settings, if screen capture of another device is enabled in local settings of the mobile phone 330, the screen capture instruction enables the user interface 331 of the mobile phone 330 to be captured. Alternatively, in some embodiments, based on screen capture settings, if screen capture of another device is disabled in local settings of the mobile phone 330, the screen capture instruction is not executed. Additionally or alternatively, in some other embodiments, based on the screen capture settings, if screen capture of the another device is disabled in the local settings of the mobile phone 330, the tablet computer 310 displays, in response to data received from the mobile phone 330 and indicating that the screen capture instruction is rejected, a pop-up window on the user interface 311, to ask the user whether screen capture of the mobile phone 330 is enabled. Detailed screen capture settings are described below.

The first device being associated with the second device may indicate that a specific connection relationship exists between the first device and the second device. For example, an account for logging in to the first device is associated with an account for logging in to the second device (for example, under a same account, or a parent account and a child account), a network in which the first device is located is associated with a network in which the second device is located (for example, the first device and the second device are located in a same network), and a distance between the first device and the second device is less than a threshold distance. In some embodiments, the tablet computer 310 can capture a screen of another device only when the tablet computer 310, the personal computer 320, the mobile phone 330, and the smart screen 340 log in to an account at the same time and are in an active state (for example, a screen-on state) at the same time, a distance among these devices is less than 5 meters (for example, each device is in a circle with the tablet computer 310 as a center and having a radius of 5 meters), and these devices are in a Wi-Fi connection at the same time. Alternatively, in some other embodiments, the tablet computer 310 can capture a screen of another device only when the tablet computer 310, the personal computer 320, the mobile phone 330, and the smart screen 340 log in to an account at the same time and are in same Wi-Fi at the same time. In this manner, the user can perform screen capture operations on devices connected in various manners. This expands an application scope of the screen capture operation, and improves user experience.

Additionally or alternatively, when a communication connection is established between devices or a screen capture operation is triggered, an identification and authentication operation may be performed on the device. The identification and authentication operation includes but is not limited to camera facial recognition, fingerprint recognition, and wearable device (like a watch) recognition. This can help determine whether the communication connection between the devices is established by a same user, to avoid a risk of suddenly capturing a screen of the device when another user borrows the device nearby.

It may be understood that the first device or the second device may have a plurality of displays. The screen capture operation may be an operation of capturing a plurality of screens of the first device, and the screen capture instruction may be an instruction instructing to capture a plurality of screens of the second device.

In a block 540, the first device receives a second screenshot image for the second user interface from the second device. In some embodiments, the foregoing example is still used for description, and the mobile phone 330 may directly send a captured image to the tablet computer 310. Alternatively, in some other embodiments, the mobile phone 330 may send a captured image to a memory, for example, a cloud server, and then send an address of the image to the tablet computer 310.

In a block 550, the first screenshot image and the second screenshot image are displayed on the first user interface. In some embodiments, the tablet computer 310 may display a screenshot image of the tablet computer 310, a screenshot image of the personal computer 320, a screenshot image of the mobile phone 330, and a screenshot image of the smart screen 340 in the screenshot display window 312 at a predetermined priority.

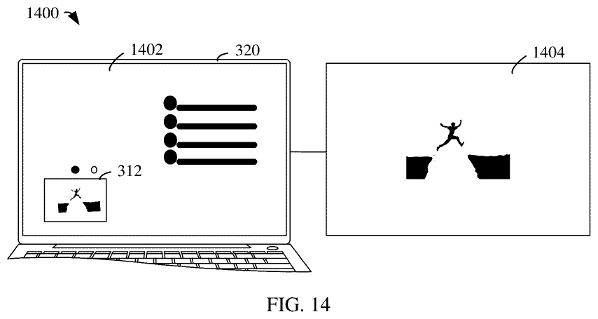

Alternatively, in some embodiments, as shown in FIG. 14, the personal computer 320 has two or more displays as described above, for example, a first display 1402 and a second display 1404, and the first display 1402 and the second display 1404 share a same host. The personal computer 320 may display screenshot images of the two or more displays in the screenshot display window 312 at a predetermined priority.

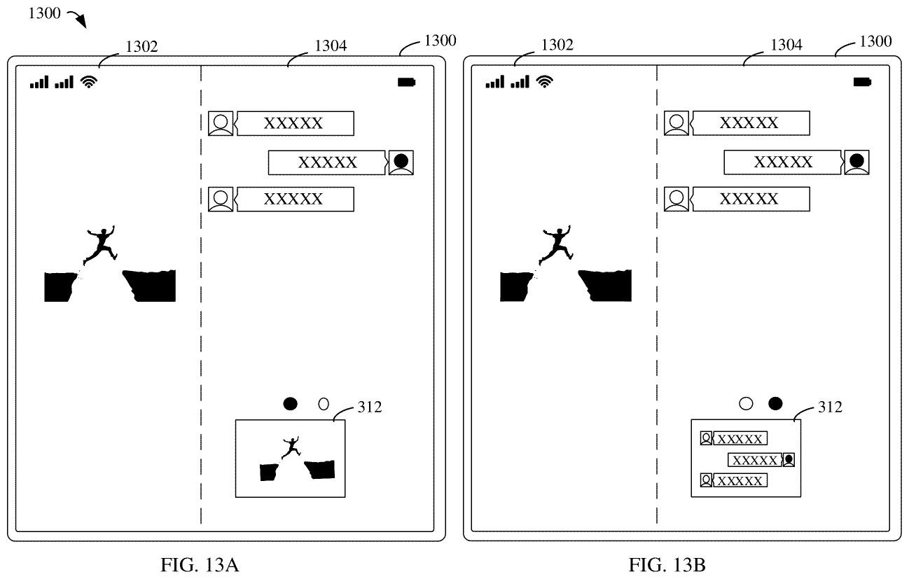

Additionally or alternatively, in some embodiments, as shown in FIG. 13A and FIG. 13B, when one of the first device and the second device is a foldable device (for example, a foldable phone 1300), the foldable phone 1330 may be operated in a split-screen mode (indicated by a dashed line), that is, a video is played on a half screen (for example, a screen 1302) of a foldable screen, and a chat is displayed on the other half screen (a screen 1304). In this case, if a screen capture operation is received on the screen 1304, the mobile phone 1300 simultaneously separately captures a user interface of the screen 1302 as a screenshot image A, and captures a user interface of the screen 1304 as a screenshot image B. The mobile phone 1300 may display the screenshot image A, the screenshot image B, and a screenshot of another device associated with the mobile phone 1300 in the screenshot display window 312 at a predetermined priority. Therefore, in a split-screen mode of a foldable device, images of two screens instead of images of an entire screen are separately captured, to reduce steps of segmenting a screenshot image by the user. This improves user experience.

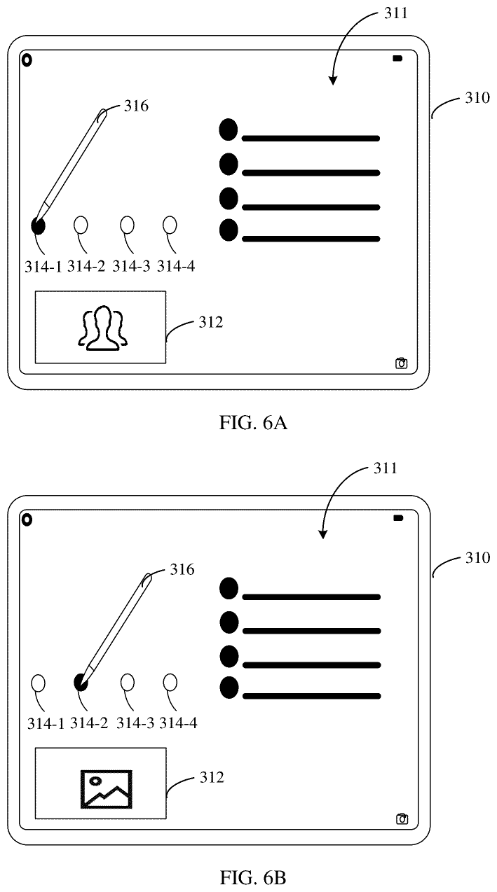

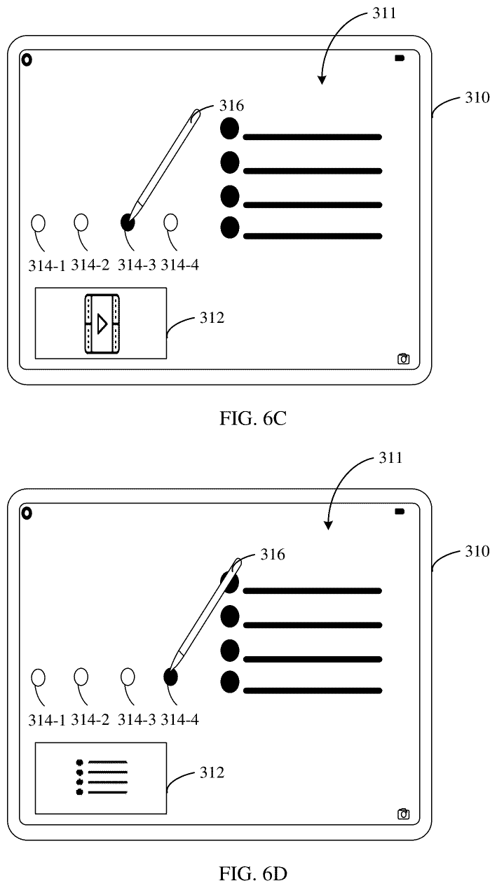

It may be understood that, in this disclosure, a screen of another associated device may be captured on one device, and different user interfaces of a same device may be captured as different screenshot images. This provides a convenient screen capture operation and reduces complexity of the screen capture operation. The following describes methods and steps in the blocks 510 to 540 in detail with reference to FIG. 6 to FIG. 12.

FIG. 6A to FIG. 6D are diagrams of graphical user interfaces (GUIs) of screen capture switching according to an embodiment of this disclosure. After receiving a screen capture operation, the tablet computer 310 may display, on the user interface 311, the screenshot display window 312, a switching identifier 314-1 associated with a screenshot of the personal computer 320, a switching identifier 314-2 associated with a screenshot of the mobile phone 330, a switching identifier 314-3 associated with a screenshot of the smart screen 340, and a switching identifier 314-4 associated with a screenshot of the tablet computer 310. In some embodiments, a quantity of switching identifiers 314 may be the same as a total quantity of devices. Alternatively, in some embodiments, when a device (for example, a computer) has two displays, a quantity of switching identifiers 314 may be greater than a total quantity of devices. Additionally or alternatively, in some embodiments, if a screen-captured device has a screen capture disabling setting, a quantity of switching identifiers 314 may be less than a total quantity of devices.

In some embodiments, as shown in FIG. 6A to FIG. 6D, when the tablet computer 310 receives a tap operation of the stylus 316 at the switching identifier 314 (a black circle indicates that the tap operation is received, and a white circle indicates that the tap operation is not received), the tablet computer 310 may correspondingly display, in the screenshot display window 312, screenshots associated with the switching identifier 314-1 to the switching identifier 314-4. Alternatively, in some other embodiments, four screenshots may be simultaneously displayed in the screenshot display window 312. For example, the screenshot display window 312 may be divided into four areas of a same size or different sizes, and each area is used to display one screenshot. In this manner, when the user completes the screen capture operation and intends to perform a further operation on a screenshot, a screenshot of each device can be displayed in a timely manner. This improves efficiency of the screen capture operation.

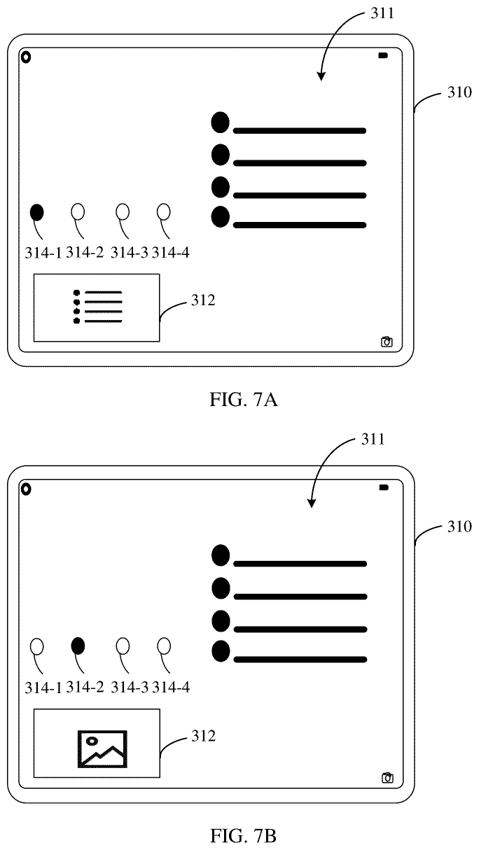

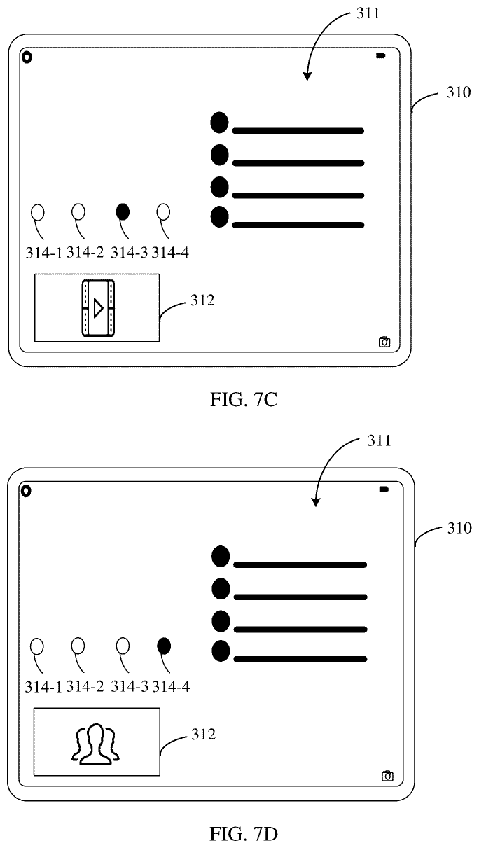

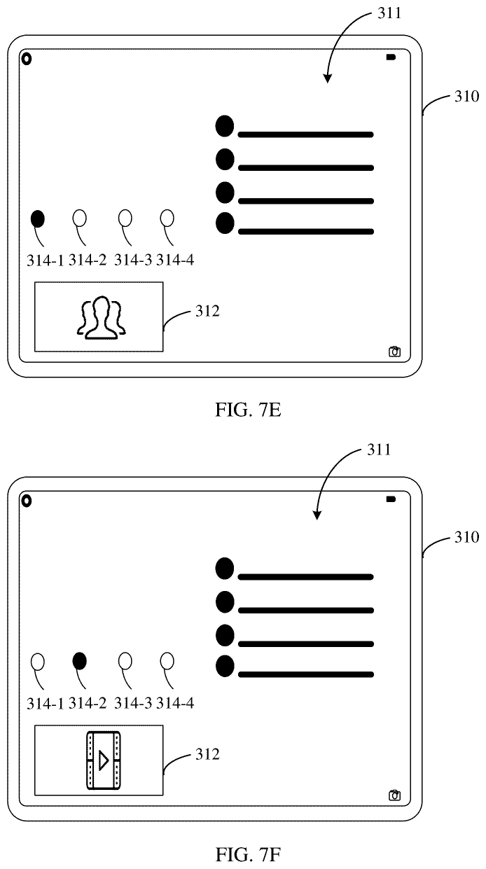

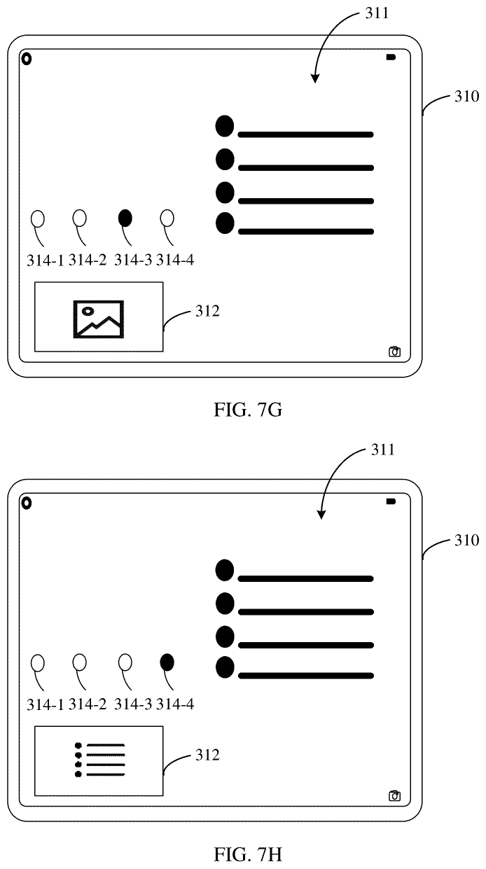

FIG. 7A to FIG. 7H are diagrams of GUIs of screenshot display priority determining according to an embodiment of this disclosure. When only one screenshot is displayed in the screenshot display window 312, a priority for displaying a screenshot needs to be determined. FIG. 7A to FIG. 7D show screenshot display priority determining during screen capture for the first time. In some embodiments, for example, the tablet computer 310 is a screen capture triggering device. When the tablet computer 310 receives a screen capture operation for the first time, the tablet computer 310 displays a screenshot of the tablet computer 310 on the user interface 311 at a first priority (as shown in FIG. 7A), and displays a screenshot of the mobile phone 330 on the user interface 311 at a second priority (as shown in FIG. 7B), where the first priority is higher than the second priority. That the first priority is higher than the second priority means that a screenshot for a user interface of the screen capture triggering device is preferentially displayed in the screenshot display window 312 by default when a screen is captured for the first time. Since there is no previous screen capture operation or additional screen capture operation when the user captures a screen for the first time, a user intention cannot be guessed. In this case, a screenshot of the screen capture triggering device itself is displayed according to default logic. Therefore, although a cross-device screen capture method is different from a conventional screen capture method, display in a default manner familiar to the user is not unfamiliar to the user. This improves user experience.

Alternatively, in some embodiments, a priority of a currently displayed screenshot may be determined based on whether the user performs a subsequent operation on the screenshot last time. For example, the foregoing example is still used for description. In a previous screen capture operation, the tablet computer 310 determines that the user does not perform an operation on a screenshot of the tablet computer 310 that is preferentially displayed in the screenshot display window 312, but performs a target operation (for example, insert, edit, or save) on a screenshot of the personal computer 320. The target operation is described in detail below. In a current screen capture operation, as shown in FIG. 7E, the screenshot of the personal computer 320 is preferentially displayed in the screenshot display window 312 compared with the screenshot that is of the tablet computer 310 and that is not operated in the previous screen capture operation. Therefore, a priority of a currently displayed screenshot image is determined based on the previous screen capture operation selected by the user. This further reduces a switching operation required by the user and improves user experience.

Additionally and or alternatively, in some other embodiments, a priority of a currently displayed screenshot may be determined based on time at which the user selects and operates the screenshot last time. For example, refer to FIG. 7A to FIG. 7D. When a screen is captured for the first time, display priorities in the screenshot display window 312 are in descending order: the screenshot of the tablet computer 310, the screenshot of the mobile phone 330, a screenshot of the smart screen 340, and the screenshot of the personal computer 320. The user performs target operations on some of the screenshots after the screenshots are displayed. For example, the user first performs a saving operation on the screenshot of the personal computer 320, then performs an editing operation on the screenshot of the smart screen 340, and performs an insertion operation on the screenshot of the personal computer 320, and does not perform an operation on the screenshot of the tablet computer 310. In this case, a priority of displaying a current screenshot is associated with time at which a previous screenshot image is operated. For example, as shown in FIG. 7E, if the tablet computer 310 determines that the screenshot of the personal computer 320 is operated first during previous screen capture, the screenshot of the personal computer 320 is displayed at the highest priority. In addition, as shown in FIG. 7F to FIG. 7H, screenshots sequentially corresponding to switching identifiers 314-2 to 314-4 arranged from left to right are sequentially displayed. It should be understood that the priority herein may be a left-to-right arrangement sequence of the switching identifiers 314. Therefore, when the user performs operations on a plurality of images, a priority of a currently displayed screenshot image is determined based on time at which the user performs an operation on a different screenshot in a previous screen capture operation, so that a screenshot mostly needed by the user is preferentially displayed. This improves user experience.

Additionally or alternatively, in some other embodiments, a screenshot may be always displayed at a predetermined priority based on settings, that is, the screenshot is displayed at a same priority during next screenshot display regardless of whether the screenshot is operated or regardless of time at which the screenshot is operated.

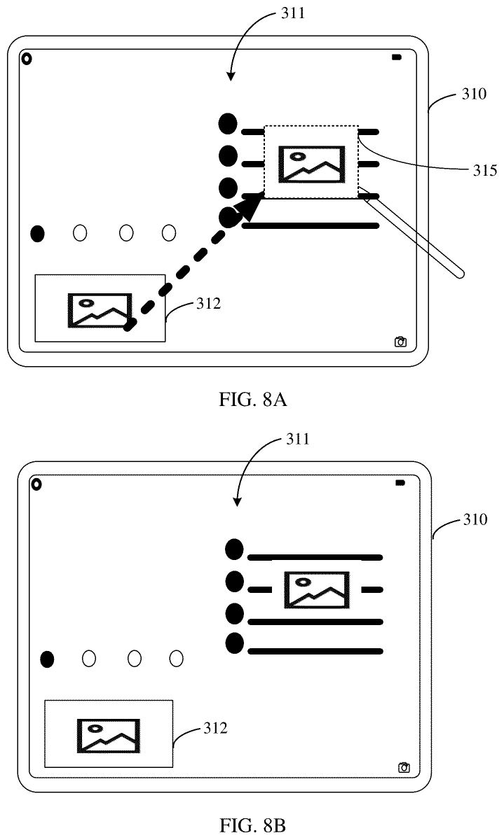

The foregoing describes the screenshot display priority, and the following describes a target operation for a screenshot. After a screenshot is displayed, if a target operation for the displayed screenshot is detected, the screen capture triggering device performs the target operation on the corresponding screenshot. The target operation may be saving, inserting, editing, or an operation associated with an application displayed on a user interface. The target operation will be described below with reference to FIG. 8 to FIG. 11.

FIG. 8A and FIG. 8B are diagrams of GUIs of screenshot insertion according to an embodiment of this disclosure. It may be understood that, when a user takes notes by using the tablet computer 310 and watches a video by using another device, the user may need to insert some important pictures in the video into the notes. In this scenario, a target operation may be an operation of inserting at least one screenshot image at a target location on an application interface.

In some embodiments, as shown in FIG. 8A and FIG. 8B, in order to insert a screenshot at a target location 315, if a drag operation for the screenshot (for example, the user performs the drag operation with the stylus 316) is received, the tablet computer 310 displays an animation of moving the screenshot with the drag operation on the user interface 311 of the application interface, and if a release operation for the screenshot (for example, the stylus 316 no longer contacts a display of the tablet computer 310) is received at the target location 315, the screenshot is inserted at the target location 315 on the application interface. It should be understood that the drag operation is merely an implementation of an insertion operation, and there may be another proper manner for inserting the screenshot into the application interface. This is not limited in this disclosure. In this manner, the user can insert the screenshot based on a simple drag operation. This improves user experience.

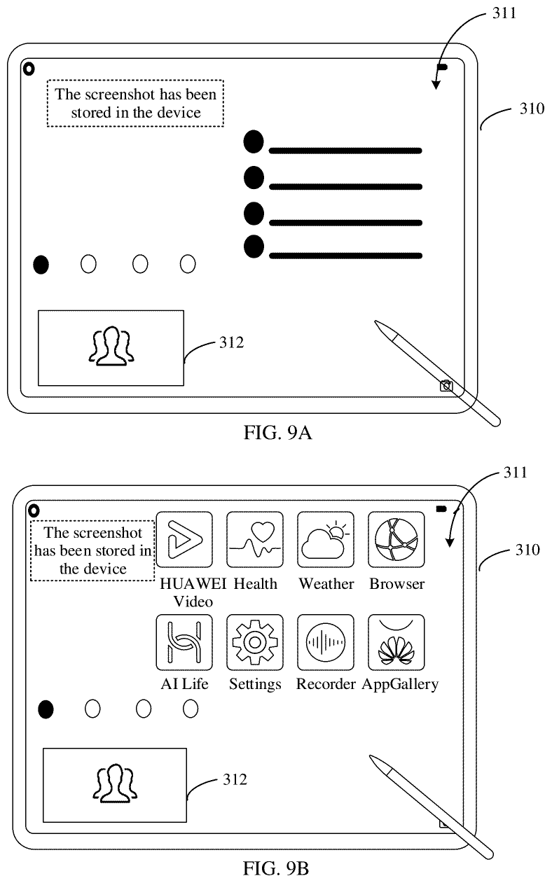

FIG. 9A and FIG. 9B are diagrams of GUIs of screenshot saving according to an embodiment of this disclosure. It may be understood that a user may be interested in a displayed screenshot, but currently cannot process the screenshot, and the user intends to store the screenshot for subsequent processing. In some embodiments, if the tablet computer 310 receives a tap operation in an area (for example, an area other than the screenshot display window 312) on the user interface 311 other than an area in which the screenshot is displayed, a floating window prompting “The screenshot has been stored in the device” is displayed on the user interface 311, and data associated with the screenshot is stored in a memory of the tablet computer 310. Alternatively, in some embodiments, if the tablet computer 310 determines that no operation is received within predetermined time (for example, 3 seconds) after a corresponding switching identifier is tapped, the tablet computer 310 stores data associated with the screenshot in a memory of the tablet computer 310. It may be understood that a saving operation may be performed regardless of whether the user interface is an application interface or a home screen. In this manner, the user can store a screenshot of each device just by performing the tap operation after a screen capture operation. This improves user experience.

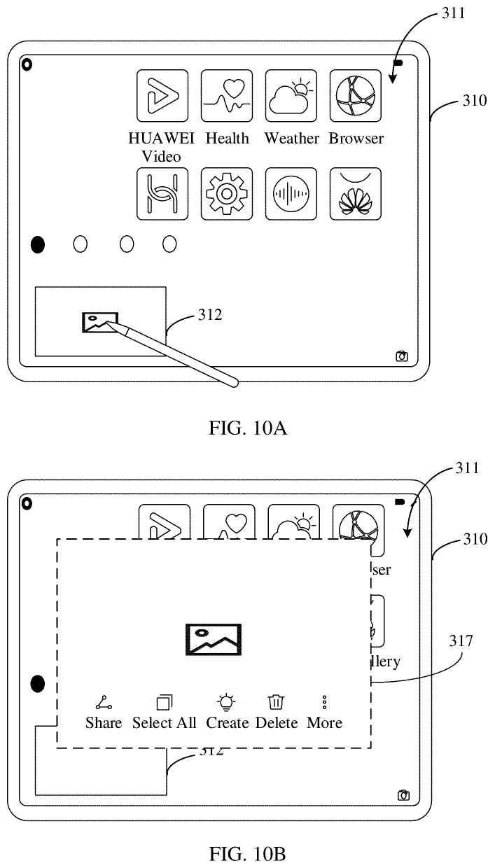

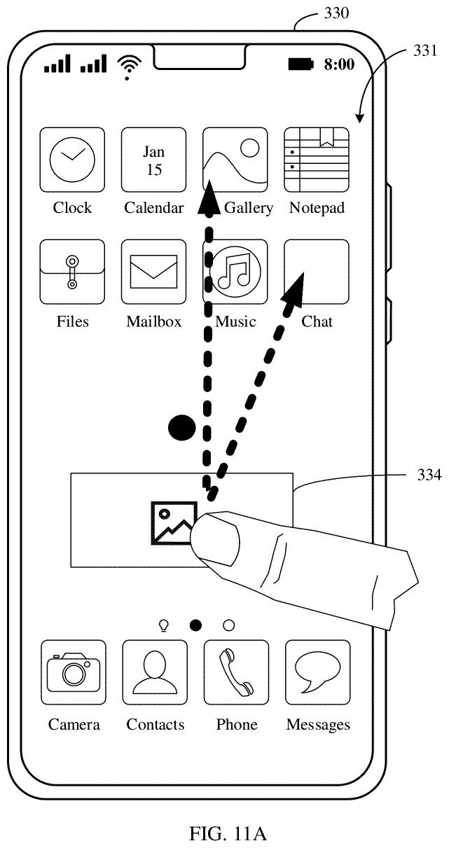

FIG. 10A and FIG. 10B are diagrams of GUIs of screenshot editing according to an embodiment of this disclosure. It may be understood that a user may be interested in a displayed screenshot and intend to edit the screenshot immediately. In some embodiments, if the tablet computer 310 receives a tap operation within an area (for example, an area within the screenshot display window 312) that is on the user interface 311 and in which the screenshot is displayed, at least one screenshot image is edited, for example, a graphic editing interface 317 is displayed on the user interface 311. It may be understood that an editing operation may be performed regardless of whether the user interface is an application interface or a home screen. In this manner, the user can edit a screenshot of each device just by performing the tap operation after a screen capture operation. This improves user experience.

It should be understood that, although the tablet computer 310 is used as a first device, namely, a screen capture triggering device, in FIG. 8 to FIG. 10, it may be understood that any device may be used as the screen capture triggering device. This is not limited in this disclosure. The following uses the mobile phone 330 as a first device, namely, a screen capture triggering device, to describe other target operations on a screenshot.

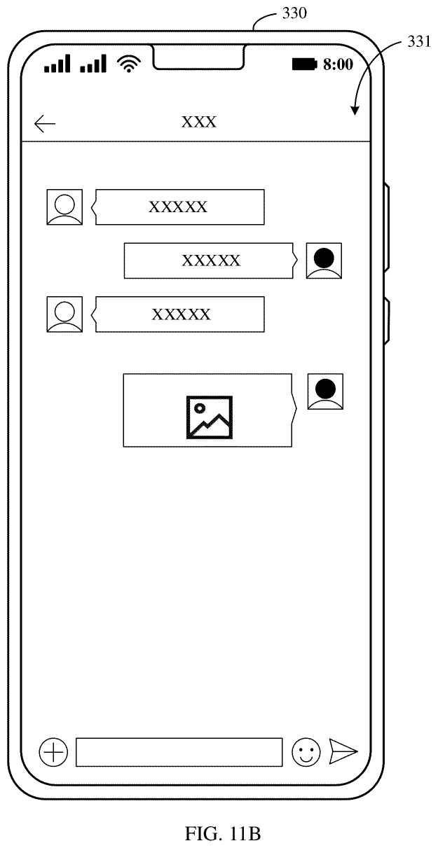

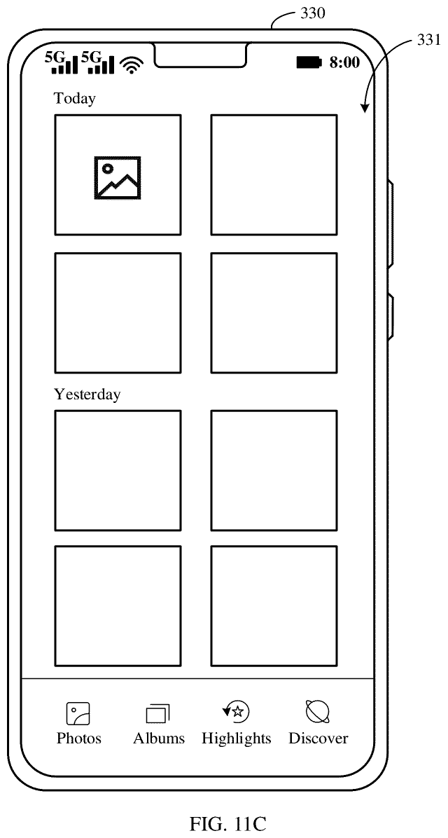

FIG. 11A to FIG. 11C are diagrams of GUIs of a further operation for a screenshot according to an embodiment of this disclosure. It may be understood that a user may be interested in a displayed screenshot and intend to perform a further operation on the screenshot in some applications. For example, if the mobile phone 330 receives, on the user interface 331 as a home screen, an operation of dragging a screenshot to an application identifier in the at least one application identifier on the home screen, the mobile phone 330 processes at least one screenshot image in an application associated with the application identifier.

In some embodiments, as shown in FIG. 11A, if the mobile phone 330 receives, on the user interface 331, an operation of dragging a screenshot to a chat application identifier on the user interface 331, the mobile phone 330 opens a chat application interface (not shown in the figure). The user may choose again to send the screenshot to a friend (as shown in FIG. 11B) in a chat application, and the user may further share the screenshot to Moments. Alternatively, in some other embodiments, if the mobile phone 330 receives, on the user interface 331, an operation of dragging a screenshot to a gallery application identifier on the user interface 331, the mobile phone 330 opens a gallery application interface (as shown in FIG. 11C). The user may perform a further operation on the screenshot in a gallery application. In this manner, the user can implement various operations on the screenshot based on a two-step operation of screen capturing and dragging, to significantly reduce a cross-device screen capture operation and a subsequent operation. This improves user experience.

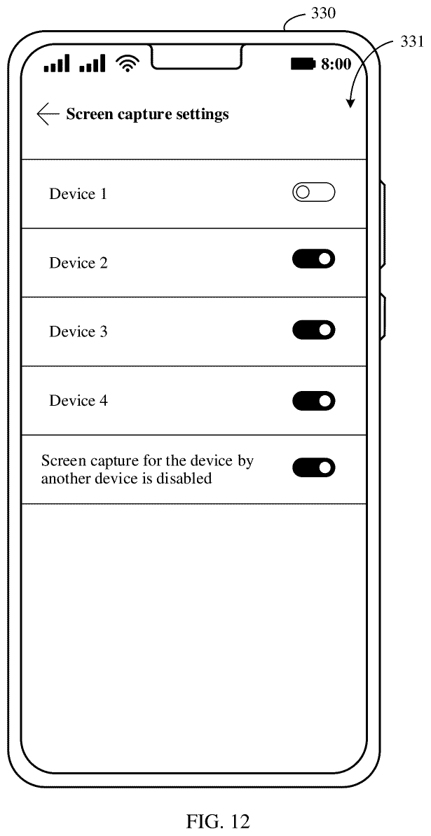

FIG. 12 is a diagram of a GUI of screen capture settings according to an embodiment of this disclosure. It may be understood that, for various reasons, a user may not intend to capture screens of some devices or intend to capture screens of only some devices. In this case, the user may disable screen capture or enable screen capture, to disable or enable screen capture functions of some of a plurality of devices.

In some embodiments, the user may set, in screen capture settings of a screen capture triggering device, screen capture disabling or enabling functions of the device and a screen-captured device. As shown in FIG. 11, the mobile phone 330 is a first device, namely, a screen capture triggering device. A list of devices associated with the mobile phone 330, for example, a device 2, a device 3, and a device 4, is displayed in the screen capture settings, where the device 1 may be the mobile phone 330. Based on the screen capture settings on the user interface 331, the device 1 is not screen-captured, and the device 2 to the device 4 are screen-captured.

Alternatively, in some embodiments, some devices may be set as screen capture disabled by default. For example, a watch is often screen-on and is usually associated with a mobile phone of the user, but the user generally does not intend to capture a screen of the watch. Therefore, the watch is set as screen capture disabled by default.

Additionally or alternatively, in some other embodiments, screen capture of another device may be disabled in local settings of a device. For example, screen capture for the device 2 is enabled in screen capture settings of the mobile phone 330, and screen capture for the device 2 by another device is disabled in screen capture settings of the device 2. In this case, the mobile phone 330 cannot obtain a screenshot for a user interface of the device 2. In other words, with regard to a screen capture disabling function, a priority of screen capture settings of a local device is higher than that of screen capture settings of another device.

In this manner, before or during a screen capture operation, the user can disable screen capture functions of some devices that are not commonly used or do not expect to be displayed, or select a device that expects to be screen-captured. This improves user experience.

This disclosure further provides a screen capture apparatus, although not shown. The apparatus includes at least the following: an instruction receiving module, configured to receive a first instruction at a first device; a screen capture module, configured to capture a first user interface of the first device as a first screenshot image in response to the first instruction; an instruction sending module, configured to send, in response to the first instruction, a second instruction to a second device associated with the first device, where the second instruction is used to trigger capturing of a second user interface of the second device; a screenshot receiving module, configured to receive a second screenshot image for the second user interface from the second device; and a screenshot display module, configured to display the first screenshot image and the second screenshot image on the first user interface.

In some embodiments, the screenshot display module may include a first display module, configured to display, on the first user interface, a screenshot display window, a first switching identifier associated with the first screenshot image, and a second switching identifier associated with the second screenshot image; a second display module, configured to display the first screenshot image in the screenshot display window in response to a received tap operation for the first switching identifier; and a third display module, configured to display the second screenshot image in the screenshot display window in response to a received tap operation for the second switching identifier.

In some embodiments, the screenshot display module may include a first priority display module, configured to display the first screenshot image on the first user interface at a first priority; and a second priority display module, configured to display the second screenshot image on the first user interface at a second priority, where the first priority is higher than the second priority.

In some embodiments, the apparatus may further include a target operation module, configured to perform, in response to a target operation that is received at the first device, the target operation on at least one of the first screenshot image and the second screenshot image.

In some embodiments, the screenshot display module may include a default display module, configured to display the second screenshot image by default on the first user interface in response to no operation for a previous screenshot image of the first device and an operation for a previous screenshot image of the second device, where the previous screenshot image is an image captured in a screen capture operation most previous to a current screen capture operation.

In some embodiments, the apparatus may further include a screen capture instruction module, configured to send, in response to the first instruction, a third instruction to a third device associated with the first device, where the third instruction is used to trigger capturing of a third user interface of the third device; and a third screenshot image receiving module, configured to receive a third screenshot image for the third user interface of the third device from the third device. The screenshot display module may include a fourth display module, configured to display the first screenshot image, the second screenshot image, and the third screenshot image on the first user interface at a predetermined priority, where the predetermined priority is associated with time at which a previous screenshot image of the first device, a previous screenshot image of the second device, and a previous screenshot image of the third device are operated, and the previous screenshot image is an image captured in a screen capture operation most previous to a current screen capture operation.

In some embodiments, the first user interface is an application interface, and the target operation module may include an insertion module, configured to insert at least one screenshot image at a target location on the application interface.

In some embodiments, the insertion module may include a drag module, configured to display, on the application interface in response to a drag operation that is received for the at least one screenshot image, an animation of moving the at least one screenshot image with the drag operation; and a drag release module, configured to insert the at least one screenshot image at the target location on the application interface in response to a release operation that is received at the target location for the at least one screenshot image.

In some embodiments, the target operation module may include a storage module, configured to store the at least one screenshot image in the first device in response to a received tap operation in an area of the first user interface other than an area in which the at least one screenshot image is displayed.

In some embodiments, the target operation module may include an editing module, configured to edit the at least one screenshot image in response to a received tap operation in an area of the first user interface in which the at least one screenshot image is displayed.

In some embodiments, the first user interface is a home screen of the first device, and at least one application identifier is displayed on the home screen. The target operation module may include an application interaction module, configured to process, in response to a received operation of dragging the at least one screenshot image onto an application identifier in the at least one application identifier, the at least one screenshot image in an application associated with the application identifier.

In some embodiments, the first device being associated with the second device indicates at least one of the following: an account for logging in to the first device is associated with an account for logging in to the second device, a network in which the first device is located is associated with a network in which the second device is located, and a distance between the first device and the second device is less than a threshold distance.

In some embodiments, the apparatus may further include a screen capture disabling module, configured to disable a screen capture function of one or more of the first device and the second device based on a screen capture disabling setting.

In some embodiments, the apparatus may further include a screen capture enabling module, configured to display, on the first user interface of the first device based on a screen capture selection setting, a screenshot of one or more devices selected from the first device and the second device.

In some embodiments, the first instruction includes at least one of the following: an operation of simultaneously pressing a power button and a volume button of the first device, a three-finger swipe-down operation, an operation of capturing a screen by opening a control center, an operation of capturing a screen by using a voice assistant, an operation of knocking a screen with a knuckle, and an operation of capturing a screen with a stylus.

The screen capture method in embodiments of this disclosure may be applied to a plurality of electronic devices. For example, the electronic device may be, for example, a mobile phone, a tablet computer, a digital camera, a personal digital assistant (PDA), a navigation apparatus, a mobile internet device (MID), a wearable device, and another device that can capture a screen. In addition, the screen capture solution in embodiments of this disclosure may not only be used as a function of an input method, but also be implemented as a function of an operating system of an electronic device.

All or some of the foregoing embodiments may be implemented by using software, hardware, firmware, or any combination thereof. When a software program is used to implement embodiments, all or some of embodiments may be implemented in a form of a computer program product. The computer program product includes one or more computer instructions. When the computer program instructions are loaded and executed on a computer, the procedures or functions according to embodiments of this disclosure are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk drive, or a magnetic tape), an optical medium (for example, a DVD), a semiconductor medium (for example, a solid-state drive Solid State Disk (SSD)), or the like.

The various examples and processes described above may be used independently of each other, or may be combined in various manners. Different combinations and sub-combinations are intended to fall within the scope of this disclosure, and some steps or processes may be omitted in some implementations. The foregoing descriptions are merely specific implementations of embodiments of this disclosure, but are not intended to limit the protection scope of embodiments of this disclosure. Any variation or replacement within the technical scope disclosed in embodiments of this disclosure shall fall within the protection scope of embodiments of this disclosure. Therefore, the protection scope of the embodiments of this disclosure shall be subject to the protection scope of the claims.

What is claimed is:

1. A method, comprising:
receiving a first instruction at a first device;
capturing a first user interface of the first device as a first screenshot image in response to the first instruction;
sending, in response to the first instruction, a second instruction to a second device associated with the first device, wherein the second instruction triggers capturing of a second user interface of the second device;
receiving a second screenshot image for the second user interface from the second device; and
displaying the first screenshot image and the second screenshot image on the first user interface.

2. The method according to claim 1, wherein displaying the first screenshot image and the second screenshot image on the first user interface comprises:
displaying, on the first user interface, a screenshot display window, a first switching identifier associated with the first screenshot image, and a second switching identifier associated with the second screenshot image;
displaying the first screenshot image in the screenshot display window in response to a received tap operation for the first switching identifier; and
displaying the second screenshot image in the screenshot display window in response to a received tap operation for the second switching identifier.

3. The method according to claim 1, wherein displaying the first screenshot image and the second screenshot image on the first user interface comprises:
displaying the first screenshot image on the first user interface at a first priority; and
displaying the second screenshot image on the first user interface at a second priority, wherein the first priority is higher than the second priority.

4. The method according to claim 1, further comprising:
performing, in response to a target operation that is received at the first device, the target operation on at least one of the first screenshot image or the second screenshot image.

5. The method according to claim 4, wherein displaying the first screenshot image and the second screenshot image on the first user interface comprises:
displaying the second screenshot image by default on the first user interface in response to receiving no operation for a previous screenshot image of the first device and receiving an operation for a previous screenshot image of the second device, wherein the previous screenshot image of the first device is an image captured in a screen capture operation on the first device most previous to capturing the first screenshot image, and wherein the previous screenshot image of the second device is an image captured in a screen capture operation on the second device most previous to capturing the second screenshot image.

6. The method according to claim 4, further comprising:
sending, in response to the first instruction, a third instruction to a third device associated with the first device, wherein the third instruction triggers capturing of a third user interface of the third device; and
receiving a third screenshot image for the third user interface of the third device from the third device; and
wherein displaying the first screenshot image and the second screenshot image on the first user interface comprises:
displaying the first screenshot image, the second screenshot image, and the third screenshot image on the first user interface at a predetermined priority, wherein the predetermined priority is associated with time at which a previous screenshot image of the first device, a previous screenshot image of the second device, and a previous screenshot image of the third device are operated, and wherein the previous screenshot image of the first device is an image captured in a screen capture operation on the first device most previous to capturing the first screenshot image, the previous screenshot image of the second device is an image captured in a screen capture operation on the second device most previous to capturing the second screenshot image, and the previous screenshot image of the third device is an image captured in a screen capture operation on the third device most previous to capturing the third screenshot image.

7. The method according to claim 4, wherein the first user interface is an application interface, and performing the target operation on at least one of the first screenshot image or the second screenshot image comprises:
inserting the first screenshot image or the second screenshot image at a target location on the application interface.

8. The method according to claim 7, wherein inserting the first screenshot image or the second screenshot image at the target location on the application interface comprises:
displaying, on the application interface in response to a drag operation that is received for the first screenshot image or the second screenshot image, an animation of moving the first screenshot image or the second screenshot image with the drag operation; and
inserting the first screenshot image or the second screenshot image at the target location on the application interface in response to a release operation that is received at the target location for the first screenshot image or the second screenshot image.

9. The method according to claim 4, wherein performing the target operation on the at least one of the first screenshot image or the second screenshot image comprises:
storing the first screenshot image or the second screenshot image in the first device in response to a tap operation that is received in an area of the first user interface other than an area in which the first screenshot image or the second screenshot image is displayed.

10. The method according to claim 4, wherein performing the target operation on the at least one of the first screenshot image or the second screenshot image comprises:
editing the first screenshot image or the second screenshot image in response to a tap operation that is received in an area of the first user interface in which the first screenshot image or the second screenshot image is displayed.

11. The method according to claim 4, wherein the first user interface is a home screen of the first device, and at least one application identifier is displayed on the home screen, and performing the target operation on the at least one of the first screenshot image or the second screenshot image comprises:
processing, in response to a received operation of dragging the first screenshot image or the second screenshot image onto an application identifier in the at least one application identifier, the first screenshot image or the second screenshot image in an application associated with the application identifier.

12. The method according to claim 1, wherein the first device being associated with the second device indicates at least one of the following:
an account for logging in to the first device is associated with an account for logging in to the second device, a network in which the first device is located is associated with a network in which the second device is located, or a distance between the first device and the second device is less than a threshold distance.

13. The method according to claim 1, further comprising:
disabling a screen capture function of one or more of the first device or the second device based on a screen capture disabling setting.

14. The method according to claim 1, further comprising:
displaying, on the first user interface of the first device based on a screen capture selection setting, a screenshot of one or more devices selected from the first device and the second device.

15. The method according to claim 1, wherein the first instruction comprises at least one of the following:
an operation of simultaneously pressing a power button and a volume button of the first device, a three-finger swipe-down operation, an operation of capturing a screen by opening a control center, an operation of capturing a screen by using a voice assistant, an operation of knocking a screen with a knuckle, or an operation of capturing a screen with a stylus.

16. An electronic device, comprising:
at least one processor; and
a non-transitory computer readable medium which contains computer-executable instructions; and
wherein the at least one processor is configured to execute the computer-executable instructions to enable the electronic device to perform operations comprising:
receiving a first instruction at the electronic device;
capturing a first user interface of the electronic device as a first screenshot image in response to the first instruction;
sending, in response to the first instruction, a second instruction to a second device associated with the electronic device, wherein the second instruction triggers capturing of a second user interface of the second device;
receiving a second screenshot image for the second user interface from the second device; and
displaying the first screenshot image and the second screenshot image on the first user interface.

17. The electronic device of claim 16, wherein displaying the first screenshot image and the second screenshot image on the first user interface comprises:
displaying, on the first user interface, a screenshot display window, a first switching identifier associated with the first screenshot image, and a second switching identifier associated with the second screenshot image;
displaying the first screenshot image in the screenshot display window in response to a received tap operation for the first switching identifier; and
displaying the second screenshot image in the screenshot display window in response to a received tap operation for the second switching identifier.

18. The electronic device of claim 16, wherein displaying the first screenshot image and the second screenshot image on the first user interface comprises:
displaying the first screenshot image on the first user interface at a first priority; and
displaying the second screenshot image on the first user interface at a second priority, wherein the first priority is higher than the second priority.

19. The electronic device of claim 16, wherein the at least one processor is further configured to execute the computer-executable instructions to perform an operation comprising:
performing, in response to a target operation that is received at the electronic device, the target operation on at least one of the first screenshot image or the second screenshot image.

20. A non-transitory computer readable medium storing computer-executable instructions, wherein the computer-executable instructions, when executed by at least one processor, enables an electronic device to perform operations comprising:
receiving a first instruction at the electronic device;
capturing a first user interface of the electronic device as a first screenshot image in response to the first instruction;
sending, in response to the first instruction, a second instruction to a second device associated with the electronic device, wherein the second instruction triggers capturing of a second user interface of the second device;
receiving a second screenshot image for the second user interface from the second device; and
displaying the first screenshot image and the second screenshot image on the first user interface.
